(19) United States
(12) Patent Application Publication
(10) Pub. No.: US 2017/0282269 A1
(43) Pub. Date: Oct. 5, 2017

(54) SHAPING OF AMORPHOUS METAL ALLOYS

(71) Applicant: Morgan Advanced Ceramics, Inc., Hayward, CA (US)

(72) Inventors: Alan DEMMONS, Woodside, CA (US); Keith FERGUSON, San Mateo, CA (US); Anthony ARENA, San Mateo, CA (US)

(73) Assignee: Morgan Advanced Ceramics, Inc., Hayward, CA (US)

(21) Appl. No.: 15/506,554

(22) PCT Filed: Aug. 25, 2015
(86) PCT No.: PCT/EP2015/069427

§ 371 Date: Feb. 24, 2017

Related U.S. Application Data
(60) Provisional application No. 62/041,782, filed on Aug. 26, 2014.

(51) Int. Cl. B23K 1/00; C22C 45/04; B21D 26/021; B23K 1/19; B23K 35/02

(52) U.S. Cl. CPC B23K 1/0008; B23K 1/19; B23K 35/0233; B21D 26/021; C22C 45/04; C22C 2200/02

(57) ABSTRACT

Disclosed is a method of brazing articles together to form at least one braze defined by complementarily curved faying surfaces on the articles, the faying surfaces each having at least one region of curvature comprising at least one point from which the surface curves in more than one direction, the method comprising the steps of: a) disposing between the complementarily curved faying surfaces at least one amorphous brazing alloy preform of complementary curvature at least in part to said at least one region of the complementarily curved faying surfaces to conform to the complementarily curved faying surfaces in said region; and b) heating the articles and at least one amorphous brazing alloy preform to a brazing temperature at which the amorphous brazing alloy flows and brazes. and brazing alloy preforms for use in such methods. Methods of forming an article comprising a curved surface from a sheet of an amorphous metal alloy are disclosed, by applying heat from a fluid to a sheet of the amorphous metal alloy to raise at least a portion of the sheet to a temperature above the glass transition temperature T_{g} and below the crystallization temperature Tₓ.

This invention relates to shaping amorphous metals.

Amorphous metals (sometimes referred to as metallic glasses or glassy metals) are solid non-crystalline metal materials that behave in many respects like glasses. Most amorphous metals are alloys, as alloying assists in inhibiting crystallization. As amorphous metals behave like glasses they soften and flow on heating, rather than showing a sharp solid-liquid transition as occurs with conventional metals.

In the following the word “sheet” is used in its broadest term as meaning a thin flat layer of solid material and includes without restriction such layers with thicknesses less than 6 mm, 4 mm, 2 mm, or 1 mm. The word “foil” is used to mean a very thin sheet and should be interpreted as including without restriction sheets less than 500 μm, 250 μm, 100 μm or below. The term “sheet” therefore encompasses the term “foil”. The invention is not limited to any particular thicknesses and is restricted only by the supply of amorphous materials in such forms.

Amorphous metals are made by a variety of methods, including for example melt spinning, in which molten metal is rapidly quenched on impact with a spinning cooled disk. The rapid cooling prevents crystallization and the material becomes a glassy solid. Melt spinning is used to make wires and thin shapes (ribbons and foils) of amorphous metal. Typically, such materials are of less than 100 μm thickness, as for most alloys thicker sections will cool too slowly to prevent crystallization. Melt spun foils of specified alloys are known for use as brazing materials, low hysteresis magnetic foil, and grain boundary free corrosion resistant high chromium and silicon containing alloys. As examples of brazing materials, melt spun foils (MSF) are obtainable of the following illustrative compositions (shown in wt %) obtainable from Morgan Advanced Ceramics, Inc. of Hayward, Calif., under the indicated trademarks:-
56.55% Ni, 30.5% Pd, 10.5% Cr, and 2.45% B (Palnicro™-30)
73.8% Ni, 14.0% Cr, 4.5% Si, 4.5% Fe, and 3.2% B (Icronibsi™-14)
82.3% Ni, 7.0% Cr, 4.5% Si, 3.2% B, and 3.0% Fe (Icronibsi™-7).

These alloys are commercially obtainable as strips up to 250 mm wide, although wider sheets are capable of manufacture. Alloys of these compositions work harden becoming too brittle to be formed into foils conventionally, whereas the amorphous nature of melt spun foils make them flexible but not ductile.

The present invention is not limited to these alloys but extends to any amorphous metal alloy.

Some amorphous alloys may be produced in thicker sections [so-called bulk metallic glasses]. Bulk metallic glasses can be injection molded, but to date none are known to be useful as brazing materials, or in magnetic applications or where a glassy phase inhibits corrosion and grain boundary related application problems.Critical temperatures in the processing of amorphous glasses are T_{g}, the glass transition temperature, and Tₓ, the crystallization temperature.

These temperatures of import are not altogether fixed but are influenced by heating and cooling rates. For a given material, T_{g} is the temperature above which the material behaves as a viscous liquid and below which it behaves as a glass. One definition refers to viscosity, fixing Tg at a temperature above which the viscosity is less than 10¹² Pa·s. T_{g} transition is markedly affected by composition and is known to change several orders of magnitude near the melting point of the alloy.

Tₓ is the temperature at which crystallization commences. This is a more complex concept, since left for long enough any glass will crystallize. Tₓ is best considered as the temperature above which crystallization will commence when a material is held above Tₓ for a specified time.

Amorphous brazing alloys are typically sold as foil, as ribbon, or as preforms cut from the foil for use in the flat or when curved to fit a surface within the limits of flex of the foil. Conventional melt spun brazing alloy foils are, in effect, 2D shapes of a generally uniform thickness.

U.S. Pat. No. 6,551,421 discloses a method of brazing amorphous metal alloys in the form of a foil which can be bent into three-dimensional preforms. The preforms are formed by bending or stamping the foil such that the deformation of the foil is irreversible so that it does not spring back to shape. To prevent spring back to flat form, U.S. Pat. No. 6,551,421 requires the use of small radius bends in the preform (radius of curvature of not more than approximately 1 millimeter). U.S. Pat. No. 6,551,421 is directed to methods for brazing shell and tube heat exchangers, and an amorphous brazing alloy preform is shown comprising tabs that are folded to allow the preform to be interposed between an end plate and a shell. In one embodiment the end plate has a tapered edge and the opposed surface to which the end plate is brazed is cylindrical. It should be noted that in this arrangement the tabs do not cover the entirety of the tapered edge.

WO2011/127414 discloses a method for rapidly heating and shaping amorphous metals by using an electrical discharge in the presence of a magnetic field, the electrical discharge heating the amorphous metal so that it softens to a viscosity in the range 1Pa·s to 10⁵Pa·s (roughly in the range between runny honey and stiff peanut butter) and in which the interaction between the electrical discharge and a magnetic field results in an electromagnetic deformational force to shape the amorphous metal. In an example, a 25-50 mm (1-2″) wide ribbon of a nickel based amorphous brazing alloy was used as a “proof of concept” for the electromagnetic forming process. Problems with such a process include uniformity and scalability. Although WO2011/127414 claims to provide uniformity, it is faced with the problem that it uses electrical resistance heating so the amount of heat delivered depends upon the thickness of the material being heated. As the material deforms the thickness will change, resulting in differential heating and hence differences in temperature, and hence differences is viscosity in different parts of the material. These differences in viscosity will result in a process that will be difficult to control. These difficulties will increase with scale and will combine with other difficulties such as providing a magnetic field of suitable uniformity to permit large articles to be formed.

Complex and compound curved shapes are used in aerospace and industrial gas turbines to make the brazed assemblies of engine components and honeycomb fairing structures. Some simple surfaces (e.g. the surface of a cylinder or cone) can be covered by a planar foil bent to fit the curved surface. However, surfaces which are curved in more than one direction (e.g. a bowl; a saddle point; a protrusion) cannot be fitted by a planar foil without tearing or cockling the foil. Convex or concave surfaces cannot be fitted by a planar foil without tearing or cockling the foil. The surfaces concerned may be considered as being surfaces having at least one region of curvature comprising at least one point from which the surface curves in more than one direction. Such surfaces cannot be fitted by bending a planar surface without stretching the surface. In a similar fashion, other products may comprise curved surfaces where amorphous foil would have desirable properties (e.g. magnetic response or other alloy attributes or properties derived from both metal constituents and glass structure) but where the limited deformability of amorphous foil currently prevents its use.

Complex and compound curved shapes encountered in industry comprise one or more regions that cannot be covered by a single piece of foil without cutting or cockling. The example of applying braze alloy to braze surfaces of these shapes is conventionally accomplished by cutting and fitting small pieces of alloy in a mosaic pattern to match the required contours. This pattern is determined by trial and error so as to cover faying surfaces of articles to be brazed to form a brazed assembly. The term “faying surface” in joining means that surface of a member which is in contact with, or in close proximity to, another member to which it is to be joined. In the case of a braze, the faying surfaces are in close proximity but separated by the braze material.

Each piece of the mosaic must fit precisely to assure braze alloy wets the complete braze interface (faying surfaces). Gaps and poorly fitted edges result in braze joint flaws that cannot be reworked so fitting is both tedious and time consuming. For such complex and compound curved shapes, placing a single piece of foil over the faying surfaces would result in gaps between the foil and the surfaces.

The inventors have realized that the amorphous nature of amorphous metals enables 3D curved brazing metal preforms to be formed of complementary form to faying surfaces with compound curves and thereby conform to the faying surfaces. This enables better brazing of complex faying surfaces.

Accordingly, in a first aspect, the present invention provides a method of brazing articles together to form at least one braze defined by complementarily curved faying surfaces on the articles, the complementarily curved faying surfaces each having at least one region of curvature comprising at least one point from which the surface curves in more than one direction, the method comprising the steps of:
a) disposing between the complementarily curved faying surfaces at least one amorphous brazing alloy preform of complementary curvature at least in part to said at least one region of the complementarily curved faying surfaces to conform to the complementarily curved faying surfaces in said region; and
b) heating the articles and at least one amorphous brazing alloy preform to a brazing temperature at which the amorphous brazing alloy preform flows and brazes.

Steps a) and b) may be separated by other process steps (transitional process steps) [e.g. clamping or otherwise restricting movements of portions of the foil that are not intended to be deformed] and other process steps may precede step a) (initial process steps) or follow step b) (succeeding process steps) ([e.g. cutting the foil to shape preceding step a) or post formation machining following step b)].

In a second aspect, the present invention provides a method of forming an article comprising a curved surface from a sheet of an amorphous metal alloy, having a glass transition temperature T_{g} and crystallization temperature Tₓ, the article comprising at least one region of curvature comprising at least one point from which the surface curves in more than one direction, the method comprising the step of applying heat from a fluid to a sheet of the amorphous metal alloy to raise at least a portion of the sheet to a temperature above the glass transition temperature T_{g} and below the crystallization temperature Tₓ, for a time sufficient to permit the sheet to deform to form the at least one region of complementary curvature. The curved surfaces may comprise any required surface, including without limitation, domes, parabolic surfaces, elliptical surfaces, toroidal surfaces, ridged surfaces, hatched surfaces. The region of curvature may extend over part of the surface of the article or may extend over the entirety of the article. Parts of the article may be generally flat. Parts of the article may comprise simple curves. An example of an article formable by this method is a brazing metal preform, from an amorphous metal brazing alloy.

In a third aspect, the present invention provides a brazing metal preform comprising a sheet of an amorphous metal brazing alloy comprising at least one region of curvature comprising at least one point from which the surface curves in more than one direction with a radius of curvature in each said direction of at least 3 mm.

Further features of the invention are as set out in the claims and exemplified in the following description with reference to the drawings in which:-

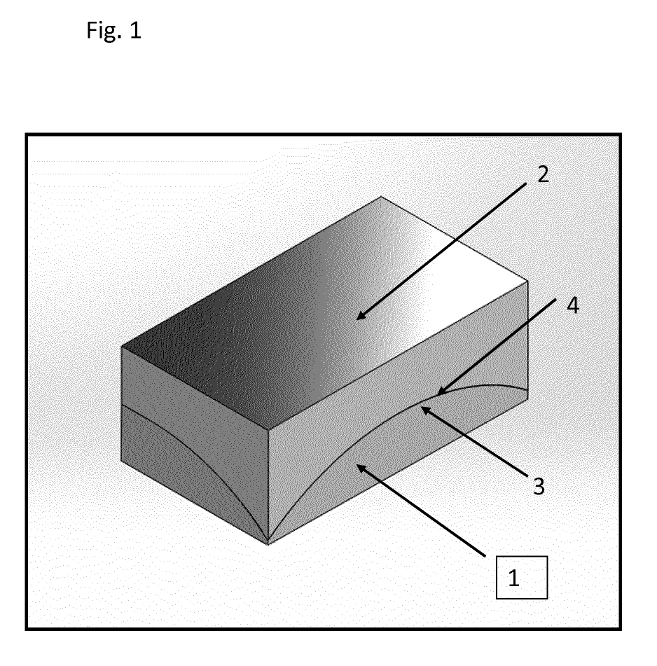

FIG. 1 is a schematic view of two articles to be brazed together

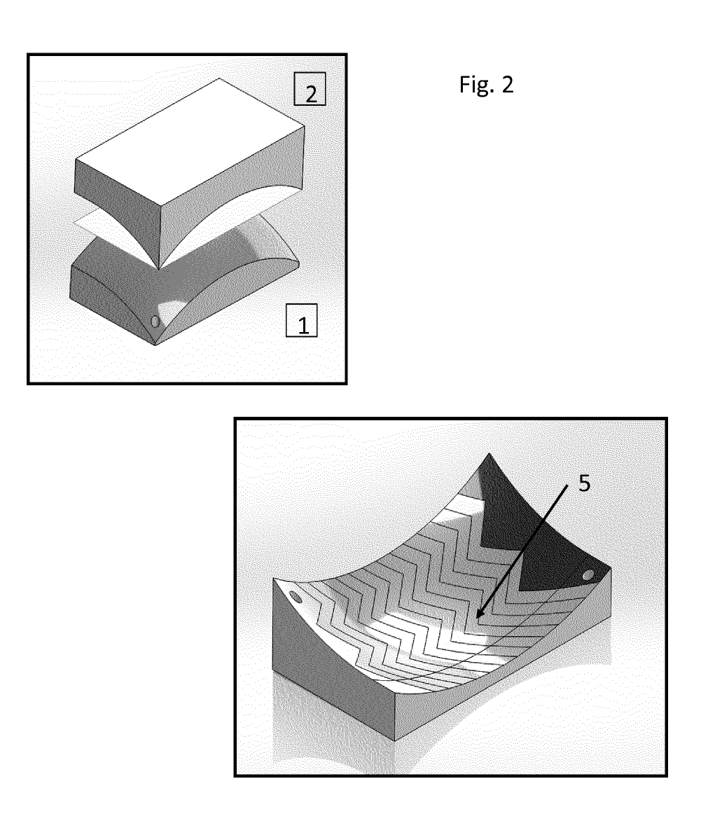

FIG. 2 is an expanded schematic view of the articles of FIG. 1 additionally showing a conventional method of brazing

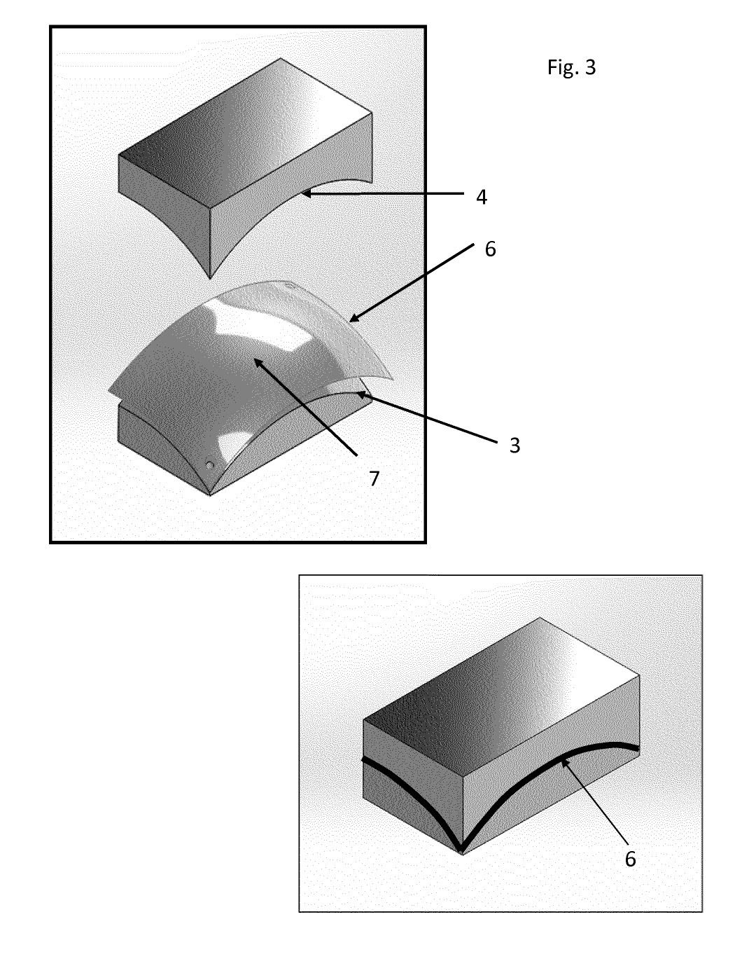

FIG. 3 is a schematic view of the articles of FIG. 1 additionally showing a brazing metal preform in accordance with the present invention;

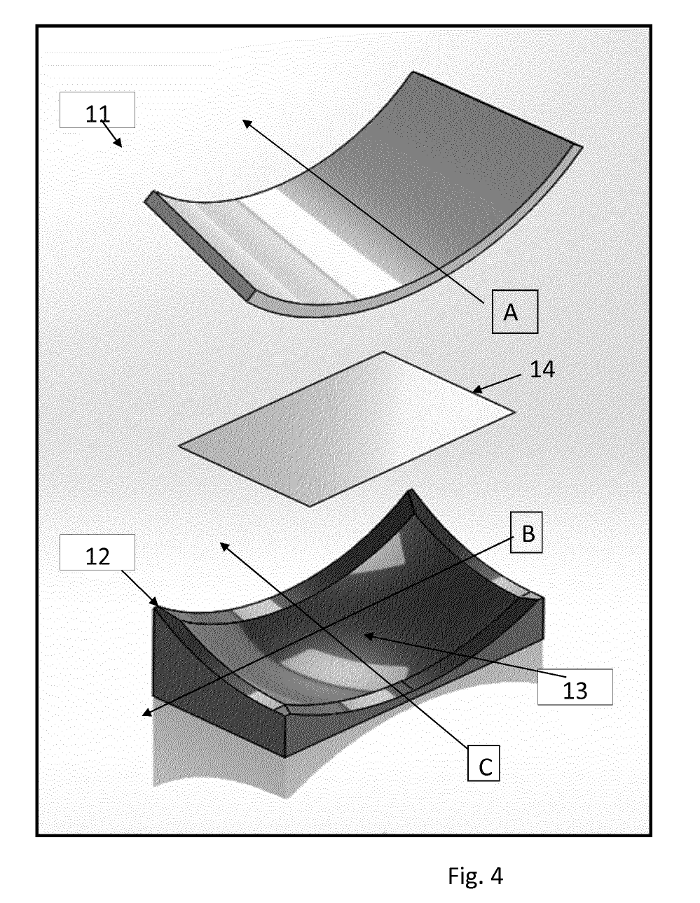

FIGS. 4-7 schematically show apparatus for forming complex curved articles and the process for forming complex curved articles.

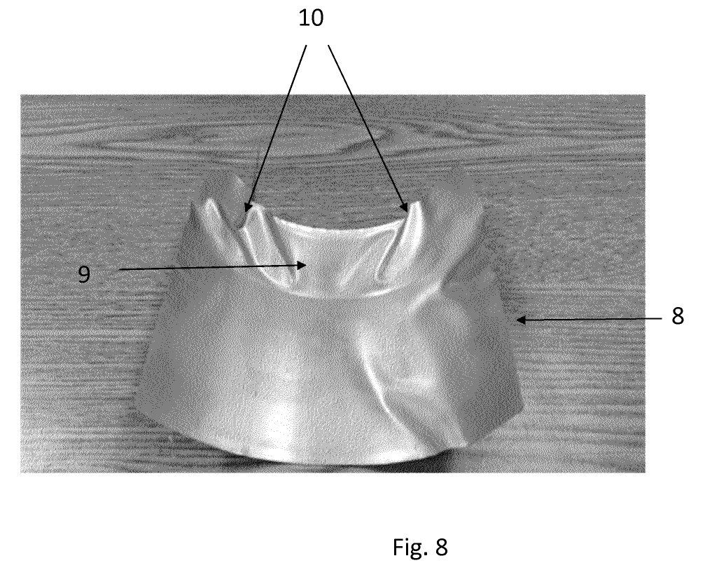

FIG. 8 is a photograph of a foil curved in accordance with the invention.

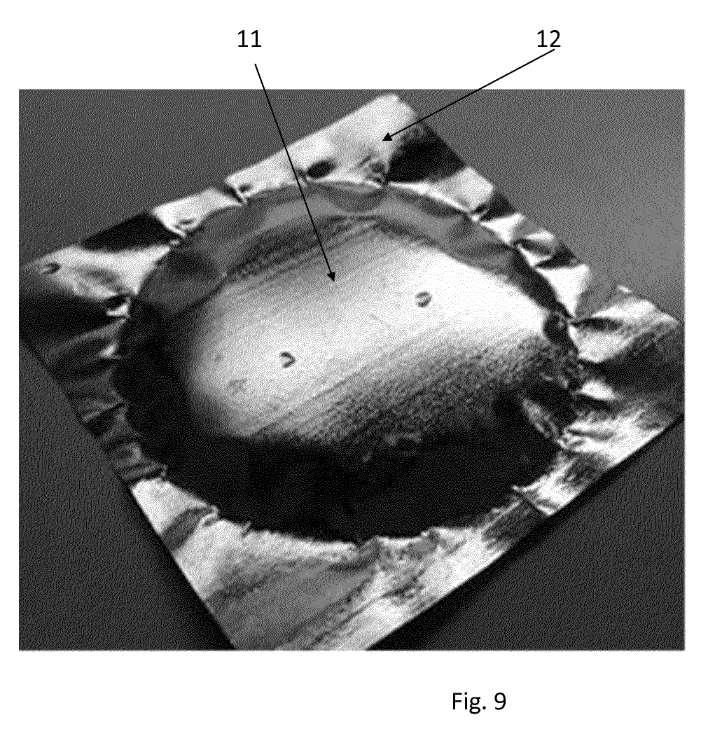

FIG. 9 is a photograph of a foil curved in accordance with the invention.

Articles 1,2 comprise a convex protrusion 3 on article 1 and a concave depression 4 in article 2. The convex protrusion 3 and concave depression 4 have complementary curvature such that when the convex protrusion 3 and concave depression 4 are engaged there is only a narrow gap sufficient to receive a brazing foil.

Conventionally, amorphous metal foils are cut into a plurality of shapes 5 that are fitted together in a mosaic pattern to match the contours of complementarily curved faying surfaces such as are defined at least in part by the concave depression 4.

In contrast, in one aspect, the present invention provides an amorphous metal brazing alloy preform shaped to have a complementary form to the complementarily curved faying surfaces on the articles. As indicated in FIG. 3, an amorphous metal brazing alloy preform 6 comprises or consists of a domed region 7 matching the contours of the convex protrusion 3 and concave depression 4. It should be noted that the invention is not limited to surfaces that are entirely curved but also encompasses surfaces that are curved in part and flat in part.

Such a preform can be made by deforming a sheet of the amorphous metal at a temperature above the glass transition temperature T_{g} and below the crystallization temperature Tₓ, for a time sufficient to form the at least one region of complementary curvature.

Typically, an amorphous metal foil is heated above the foil T_{g} in a tool with a desired conformal shaped surface on one side and applying a uniform force to the non-conformal foil face after a the T_{g} has been exceeded by a suitable amount. The force may be applied through gravity; with a complementarily shaped tool; by a deformable bladder; by blow moulding or any other process that permits the metal to deform to the desired shape. By performing operations on the heated amorphous metal foil at a temperature above T_{g} and below Tₓ reconfiguring from a flat foil to a shaped preform (foil) is accomplished while amorphous properties are maintained.

As mentioned above, T_{g} and Tₓ depend upon the alloy used. Experimentally determined T_{g} ranges for the alloys mentioned above are tabulated below:-

| | Liquidus | Solidus | T_{g} ° C. |
|---|---|---|---|
| Alloy | ° C. | ° C. | nominal |
| 56.55% Ni, 30.5% Pd, 10.5% Cr, | 977 | 941 | 200-230 |
| and 2.45% B (Palnicro ™ -30) | | | |
| 73.8% Ni, 14.0% Cr, 4.5% Si, 4.5% | 1094 | 960 | 230-260 |
| Fe, and 3.2% B (Icronibsi ™ - 14) | | | |
| 82.3% Ni, 7.0% Cr, 4.5% Si, 3.2% | 1024 | 969 | 215-250 |
| B, and 3.0% Fe (Icronibsi ™ - 7). | | | |

As indicated above, Tₓ varies according to time exposed to temperature. For example, for the above alloys, forming at times less than about 15-20 minutes at a temperature within the above T_{g} ranges preserves amorphous qualities within the foil, although the invention is not restricted to that range. Lot chemistry is known to produce pronounced changes in the liquidus and solidus temperatures. Similarly T_{g} does vary with chemistry.

Typically, a mold/fixture surface of a negative shape contour is made from any material suitable for the temperature used in the glass phase forming. Provision for heating the foil can be either in the mold/fixture or alternately heating may be done in an oven/furnace either in atmosphere/vacuum/air/or suitable fluid medium as determined by the alloy to be formed. The heating method used must provide precision and control for repeatability. A useful method is by supplying heat and pressure to the foil by delivering heat from a fluid (for example a liquid, gas, supercritical fluid or plasma), Useful fluids for this purpose include saturated steam or superheated steam since these allow rapid delivery of heat to the alloy in a controllable manner. The use of fluids to deliver the heat to the foil provides a relatively uniform delivery of heat across the foil. It is useful in forming to hold immobile the edges and/or other regions where shaping/deformation will not occur.

Following heating of the foil to above the T_{g} of foil to be shaped, pressure applied to the foil forces it into contact with the surface of the desired shape of the negative contour. During forming the foil stretches and flows with some thinning while in the glass like state, however with suitable temperature control between T_{g} and Tₓ, amorphous quality of the foil is maintained as is a great degree of the metal foil like flexibility. Pressure may be applied by a variety of means, but where a fluid is used for heating (as claimed herein), the fluid can also be used to provide pressure to the foil, to deform the foil once it is above T_{g}. It should be noted that the viscosity of the amorphous metal does not need to be as low as in WO2011/127414 for this process to work, and forming and cooling of the deformed amorphous metal sheet can be performed while retaining predominantly amorphous character to the sheet.

The scalability of heating with fluids permits large products to be made, for example having dimensions in two orthogonal directions of greater than 100 mm.

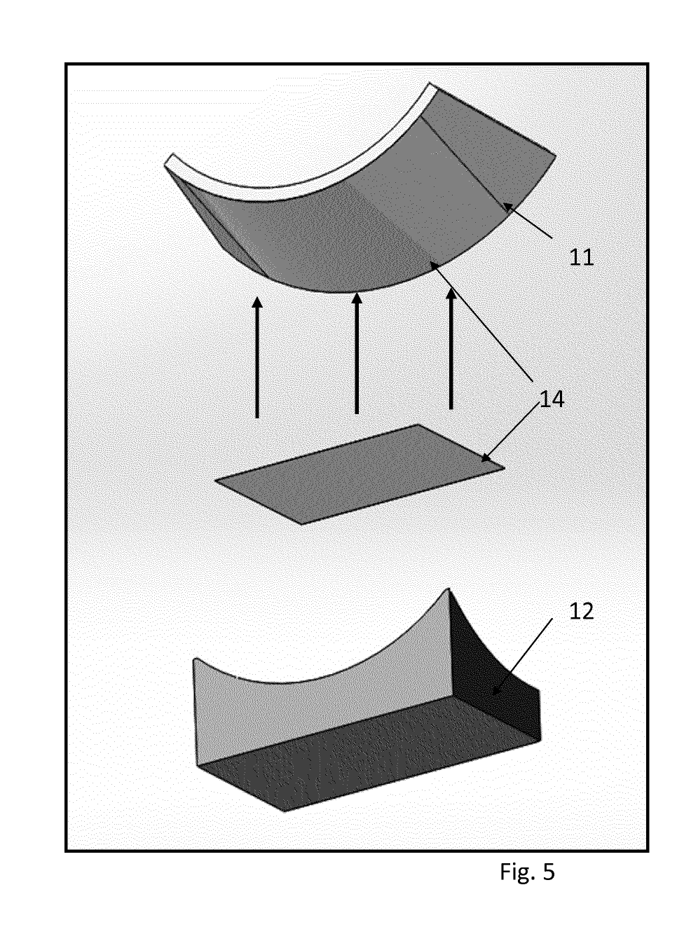

FIGS. 4 and 5 shows a simple curved tool 11 curving about one axis A: a complex curved tool 12 having a surface 13 that curves about two axes B,C; and an amorphous foil 14.

FIG. 5 shows the foil 14 being applied to conform to the simple curve of the underside of the simple curved tool 11.

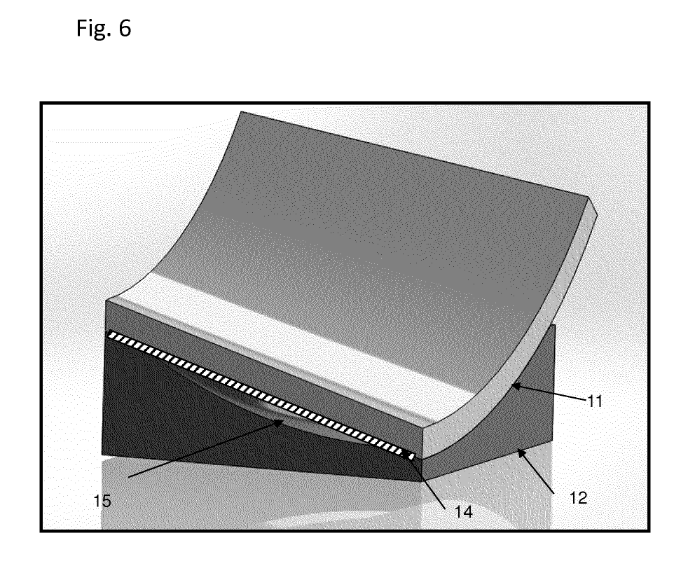

FIG. 6 shows a section of simple curved tool 11, amorphous foil 14 and complex curved tool 12. A gap 15 is shown between the simple curved tool 11 and complex curved tool 12 that is a consequence of their differing curvatures. Pressure applied to urge the simple curved tool 11 towards complex curved tool 12 results in the foil 14 being held at each end where the simple curved tool 11 and complex curved tool 12 abut. Other means of retaining the edges of the foil 14 may be envisaged, for example dedicated clamps.

The foil in the assembly of simple curved tool 11, amorphous foil 14 and complex curved tool 12 is then exposed to a temperature above the glass transition temperature T_{g} and below the crystallization temperature Tx, for a time sufficient for the foil to deform to match the surface of the complex curved tool 12, to form at least one region of curvature comprising at least one point from which the surface curves in more than one direction.

The curvature at the at least one point from which the surface curves in more than one direction can be of any desired value that in combination with the size of the foil does not result in excessive thinning of the foil. Contrary to the limitations of U.S. Pat. No. 6,551,421 , the radius of curvature is not limited to small values such as not more than approximately 1 mm. Accordingly the present disclosure claims brazing alloy foils having a radius of curvature in each direction at the at least one point from which the surface curves in more than one direction of at least 3 mm: curvatures of at least 10 mm, or at least 50 mm, or at least 100 mm, or at least 1 meter, or even more can be accommodated. Other points on the preform may have radii of curvature of less than 3 mm.

For some alloys gravity may be enough to permit the foil to slump to conform to the complex curved tool 12. For others pressure may be required to be applied. Pressure can be applied in many ways, for example:-
by providing a deformable simple curved tool 11 and applying pressure to its upper surface;
by providing a bladder between the simple curved tool 11 and amorphous foil 14 and supplying fluid under pressure to the bladder so that it distends to deform the amorphous foil 14;
by providing fluid channels in the simple curved tool 11 communicating with the curved face against which the amorphous foil 14 is applied and supplying a fluid under pressure through the fluid channels to deform the amorphous foil 14.

[In the latter cases, the fluid under pressure may also be the means of supplying the heat as is described further below with reference to FIG. 9].

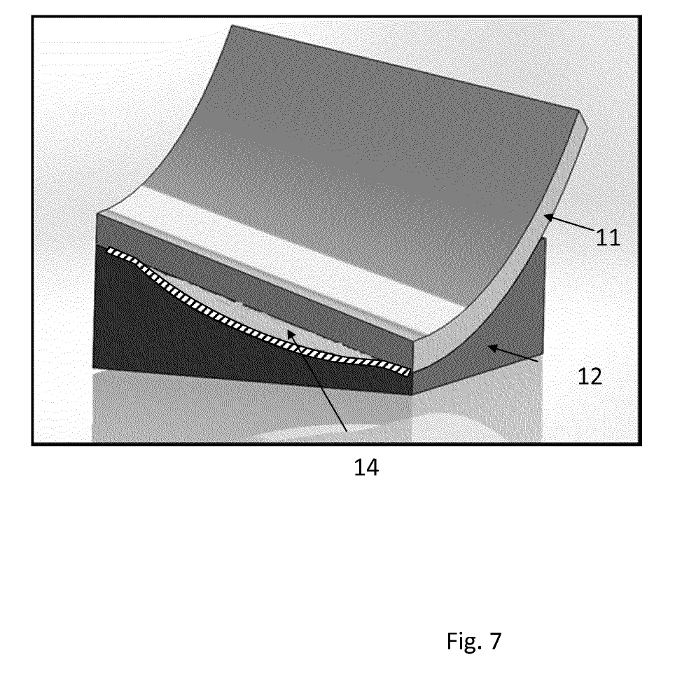

FIG. 7 shows the foil 14 in the deformed state, held at its edges by the simple curved tool 11 and complex curved tool 12 and lying adjacent the complex curved tool 12.

FIG. 8 shows a preform formed in accordance with the invention and comprising a generally cylindrical portion 8 and a generally conical portion 9. The preform was formed from Icronibsi-7™ at a forming temperature of 240° C. The foil was at temperature for 40 minutes and subsequently cooled to room temperature to produce an amorphous foil preform. Wrinkles 10 show the flexible nature of the preform but in use the foil would conform to a surface comprising a cylinder leading into a cone.

FIG. 9 shows an amorphous metal brazing alloy preform formed in accordance with the invention and comprising a generally domed portion 11 having a radius of curvature of approximately 625 mm and a generally flat portion 12. The radius of the base of the dome was approximately 90 mm and the center of the dome stood approximately 6.5 mm above the flat portion.

The preform was formed from a foil of Icronibsi-7™ at a forming temperature nominally 240° C. Heat and pressure were supplied through use of superheated steam from a steam generator with steam pressures in the range around 7-105 kPa (1-15 psi) above atmospheric, to deform part of the sheet to conform to a mold of complementary form to the domed portion.

Multiple cycles of heat and pressure were applied over a period of minutes to test both the apparatus and the effect of cycling on the foil. Multiple cycles need not be used in production, but in some cases may be of assistance in making complex shapes [e.g. by conforming the same or different portions of the foil to different molds]. The mold was permitted to cool naturally, but forced cooling can be of assistance, and in a production environment would both shorten cycle times and reduce the risk of crystallization,

Although superheated (dry) steam was used in this example, any fluid with sufficient heat content flowing in appropriate quantities can be used to controllably raise the temperature of the amorphous metal with suitable heating rates and limiting heating to above the T_{g} without markedly changing the amorphous properties through excessive crystallization. Steam is just the most convenient fluid in most cases.

More complex shapes [e.g. bowls, elliptical surfaces, spherical surfaces, toroidal surfaces] can be made in like manner. It should be noted that at the junction between the cone and cylinder the surface of the preform curves in two directions, around the circumference of the cylinder, and along the axis of the cylinder. In this respect it should be noted that in the present specification the term “curves” includes discontinuous curves such as linear sections extending in different directions from a point.

The formed preform can be supplied alone, or if too flexible and delicate for safe transport, mounted to a support [which may be a removable part of the mold/fixture surface].

The formed preform permits easy assembly with the articles to be brazed and provides predictable and good contact with the faying surfaces, so permitting either conventional joints when raised above the alloy liquidus, or intimate contact as required for diffusion joining.

A typical alloy preform would have a thickness between but not restricted to ˜12.7 μm [0.0005″] to ˜76.2 μm [0.003″], with a length and width restricted only by the forming process of the sheet of amorphous metal brazing alloy from which it is formed.

An alloy preform may have perforations located to match intended no-braze regions to effect joint voids after suitable forming and after brazing.

An alloy preform may extend beyond the faying surfaces.

An alloy preform may be shaped or machined adding additional features that will be maintained after brazing.

For large curved surfaces more than one curved preform may be mosaicked to cover the surface.

Further features, variants, and modifications to the invention disclosed herein will be evident to the person skilled in the art. In particular, although the above disclosure refers largely to brazing alloys, it will be evident that other amorphous metals can be formed into curved forms in like manner and used in appropriate applications where the particular properties of amorphous metals are useful, and where the combination of complex curved shapes and amorphous metal properties provide benefits.

Such applications include but are not restricted to electronics, medicine, optics, heating, corrosion, or tribology, where combining amorphous metal material properties and shape improve and expand functionality.

Specific examples include but are not limited to:-
Formed shapes for hydrogen separating membranes for fuel cells.
Formed shapes as part of a laminate structure for making jet engine blades and vanes
Formed shapes of amorphous Inconel and Titanium alloys for high temp aero structures of jet engine blades and vanes.
Formed shapes for shape memory alloys used in implantable and surgical medical apparatus and devices.
Formed shapes for Li-Ion battery components.
Formed shapes for membrane screens used to disperse or propel powders or bioloical agents via vibration.
RFID tags
Hard drive pick up heads
Brazing alloy preforms for use in brazing diamond to carbide or other substrates.

The invention further includes articles formed by brazing using the brazing metal preforms described above or claimed herein.

It is to be noted that use of the term “invention” is not intended to restrict the scope of the new and inventive technologies hereby disclosed and the applicant reserves the right to claim any or all new and inventive technologies hereby disclosed.

1. A method of brazing articles together to form at least one braze defined by complementarily curved faying surfaces on the articles, the complementarily curved faying surfaces each having at least one region of curvature comprising at least one point from which the surface curves in more than one direction, the method comprising the steps of:
a) disposing between the complementarily curved faying surfaces at least one amorphous brazing alloy preform of complementary curvature at least in part to said at least one region of the complementarily curved faying surfaces to conform to the complementarily curved faying surfaces in said region; and
b) heating the articles and at least one amorphous brazing alloy preform to a brazing temperature at which the amorphous brazing alloy flows and brazes.

2. A method as claimed in claim 1 in which steps a) and b) are separated by transitional process steps.

3. A method as claimed in claim 1, in which initial process steps precede step a).

4. A method as claimed in claim 1, in which succeeding process steps follow step b).

5. A method as claimed in claim 1, in which at said at least one point from which the surface curves in more than one direction, the radius of curvature is at least 3 mm in each said direction.

6. A method as claimed in claim 5, in which at said at least one point from which the surface curves in more than one direction, the radius of curvature is at least 50 mm in each said direction.

7. A method as claimed in claim 1, in which the amorphous brazing alloy preform has dimensions in two orthogonal directions of greater than 100 mm.

8. A method of forming an article comprising a curved surface from a sheet of an amorphous metal alloy, having a glass transition temperature T_{g} and crystallization temperature Tₓ, the article comprising a surface having at least one region of curvature comprising at least one point from which the surface curves in more than one direction, the method comprising the step of applying heat from a fluid to a sheet of the amorphous metal alloy to raise at least a portion of the sheet to a temperature above the glass transition temperature T_{g} and below the crystallization temperature Tₓ, for a time sufficient to permit the sheet to deform to form the at least one region of curvature.

9. A method as claimed in claim 8, in which the fluid applies pressure to the sheet to deform the sheet.

10. A method as claimed in claim 8, in which the sheet deforms to make contact with a mold surface complementary to the at least one region of curvature.

11. A method as claimed in claim 8, in which the article comprising a curved surface is a brazing metal preform and the amorphous metal alloy is an amorphous metal brazing alloy.

12. A method as claimed in claim 8, in which at said at least one point from which the surface curves in more than one direction, the radius of curvature is at least 3 mm in each said direction.

13. A method as claimed in claim 12, in which at said at least one point from which the surface curves in more than one direction, the radius of curvature is at least 50 mm in each said direction.

14. A method as claimed in claim 8, in which the article has dimensions in two orthogonal directions of greater than 100 mm.

15. A brazing metal preform comprising a sheet of an amorphous metal brazing alloy comprising a surface having at least one region of curvature comprising at least one point from which the surface curves in more than one direction with a radius of curvature in each said direction of at least 3 mm.

16. A brazing metal preform as claimed in claim 15, comprising a part cylindrical section and a part conical section.

17. A brazing metal preform as claimed in claim 15, comprising a cylindrical section and a conical section.

18. A brazing metal preform as claimed in claim 15, comprising a domed section and a flat section.

19. A brazing metal preform as claimed in claim 15, in which at said at least one point from which the surface curves in more than one direction, the radius of curvature is at least 50 mm in each said direction.

20. A brazing metal preform as claimed in claim 15, in which the amorphous brazing alloy preform has dimensions in two orthogonal directions of greater than 100 mm.

21. A brazing metal preform as claimed in claim 15, mounted to a support.

22. A product formed at least in part using the method of claim 1.

23. A product formed at least in part using the method of claim 8.
